(19) United States
(12) Patent Application Publication
(10) Pub. No.: US 2006/0200634 A1
(43) Pub. Date: Sep. 7, 2006

(54) Data storage system and data storage control apparatus

(75) Inventors: Masahiro Yoshida, Kawasaki (JP); Takeshi Obata, Kawasaki (JP); Taichi Oono, Kawasaki (JP); Kazunori Masuyama, Kahoku (JP)

Correspondence Address: STAAS & HALSEY LLP;JIM LIVINGSTON, SUITE 700, 1201 NEW YORK AVENUE, N.W., WASHINGTON, DC, 20005, US

(73) Assignee: Fujitsu Limited, Kawasaki (JP)

(21) Appl. No.: 11/237,933

(22) Filed: Sep. 29, 2005

(30) Foreign Application Priority Data
Mar. 3, 2005 (JP) 2005-58792

(51) Int. Cl. G06F 12/00

(52) U.S. Cl. 711/148; 711/112

(57) ABSTRACT

A storage system have a control module which controls a plurality of disk storage devices, and which realizes reading/writing of system information even when problems arise in the path with a plurality of disk devices. A system disk device unit which stores system information is incorporated within the control modules which control a plurality of disk storage devices. The control modules can read/write system information even without accessing the disk storage devices.

### CROSS-REFERENCE TO RELATED APPLICATIONS

This application is based upon and claims the benefit of priority from the prior Japanese Patent Application No. 2005-058792, filed on Mar. 3, 2005, the entire contents of which are incorporated herein by reference.

### BACKGROUND OF THE INVENTION

1. Field of the Invention

The invention relates to a data storage system and data storage control apparatus, used as an external storage apparatus for a computer, and in particular relates to a data storage system and data storage control apparatus having disk devices used by users and system disk devices used by the apparatus among numerous disk devices.

2. Description of the Related Art

As data has assumed various electronic forms in recent years and has come to be handled by computers, independently of host computers executing data processing, data storage apparatus (external storage apparatus) capable of storing large amounts of data efficiently and with high reliability has become increasingly important.

As such data storage systems, disk array apparatus having large-capacity disk devices (for example, magnetic disk and optical disc devices) and disk controller used to control such large-capacity disk devices have come into use. Such disk array apparatus accepts simultaneous disk access requests from a plurality of host computers, and are capable of controlling large-capacity disks.

Such a disk array apparatus incorporates memory which acts as a disk cache. By this means, when read requests and write requests are received from a host computer, the time for data access can be shortened, and enhanced performance can be achieved.

In general, a disk array apparatus has a plurality of principal units, that is, channel adapters which are portions for connection to host computers, disk adapters which are portions for connection to disk drives, cache memory, a cache control portion which serves to control the cache memory, and large-capacity disk drives.

FIG. 10 explains the technology of the prior art. The disk array apparatus 102 shown in FIG. 10 has two cache managers (cache memory and cache control portion) 10 and each cache manager 10 is connected to the channel adapters 11 and the disk adapters 13.

The two cache managers 10, 10 are directly connected by a bus 10c so as to enable communication. Because low latency is required between the two cache managers 10, 10, and between the cache managers 10 and the channel adapters 11, and between the cache managers 10 and the disk adapters 13, a PCI (Peripheral Component Interconnect) bus is used for connection.

The channel adapters 11 are for example connected to the host computers (not shown) by means of a fiber channel or Ethernet (a registered trademark). The disk adapters 13 are for example connected to each of the disk drives in a disk enclosure 12 by means of a fiber channel cable.

The disk enclosure 12 has two ports (for example, fiber channel ports) and these two ports are connected to different disk adapters 13. By this means redundancy is imparted, and fault tolerance is improved. (See for example Japanese Patent Laid-open No. 2001-256003 (FIG. 1))

In such a large-capacity data storage system, a large amount of information (called system information) is necessary for control by controllers (the cache control portions, the channel adapters, the disk adapters and similar). For example, system information includes firmware necessary to operate controllers, backup data for the apparatus configuration, and log data for various tasks and threads.

The firmware comprises control programs for controllers; in particular, in a disk array (RAID configuration), numerous control programs are necessary. The backup data for the apparatus configuration is data used to convert from host-side logical addresses to physical disk addresses and a large amount of data is necessary, according to the number of disk devices and the number of hosts. The log data is state data for each task and thread, used for fault recovery and fault prevention, and also constitutes a large volume of data.

Such system data is generally stored in a nonvolatile large-capacity storage device; in the prior art, as shown in FIG. 10, a portion of the disk drives 120 in the disk enclosure 12 connected by cables to the disk adapters 13 was used for storage of such data. A disk drive which stores this system data is called a system disk.

That is, a portion of the numerous disk drives connected to the controllers are used as system disks, and the other disk drives are used as user disks. As a consequence of this conventional technology, as indicated in FIG. 10, any of the controllers 10 can access the system disks 120.

However, in addition to redundancy, the in recent years storage systems have been required to continue operation even upon occurrence of a fault in any portion of the system. In the technology of the prior art, if a problem arises in the path between the controller and the disk enclosure, such as for example between the disk adapter and the disk enclosure, reading and writing of the system disk 120 can no longer be executed.

Consequently even if the controller and other paths are normal, the controller cannot read firmware or apparatus configuration backup data from the system disk, and operations using other routes become difficult. Further, the controller cannot read or write log data to and from the system disk, impeding analysis upon occurrence of a fault and diagnostics for fault prevention.

Moreover, upon occurrence of a power outage it is necessary to switch to battery operation and to back up the data in cache memory to the system disk. In the technology of the prior art, in such cases power must also be supplied to the disk enclosure, so that a very large battery capacity is required. Furthermore, a comparatively long time is necessary to write backup data to a system disk via a disk adapter and cable, and when the cache memory capacity is large, a huge battery capacity is required.

### SUMMARY OF THE INVENTION

Hence an object of this invention is to provide a data storage system and data storage control apparatus capable of executing reading and writing of system disks, even when problems occur in paths between controllers and disk drives.

A further object of this invention is to provide a data storage system and data storage control apparatus enabling smaller battery capacity for backups in the event of a power outage, and which enables an inexpensive configuration.

Still another object of this invention is to provide a data storage system and data storage control apparatus enabling reading and writing of log data to a system disk, even when problems occur in paths between controllers and disk drives.

Still another object of this invention is to provide a data storage system and data storage control apparatus which, in the event of a power outage, can perform backups of cache memory data with a small battery capacity.

In order to attain these objects, a data storage system of this invention has a plurality of disk storage devices which store data, and a control module, connected to the plurality of disk storage devices, which control access to the disk storage devices according to access instructions from a higher-level host. The control module has memory having a cache area which stores a portion of the data stored in the disk storage devices; a control unit which performs the access control; a first interface portion which controls the interface with the higher-level host; a second interface portion which controls the interface with the plurality of disk storage devices; and a system disk unit, connected to the control unit, which stores system information for use by the control unit.

A data storage control apparatus of this invention is connected to a plurality of disk storage devices which store data, controls access to the disk storage devices according to access instructions from a higher-level host, and has memory having a cache area which stores a portion of the data stored in the disk storage devices; a control unit which controls access; a first interface portion which controls the interface with the higher-level host; a second interface portion which controls the interface with the plurality of disk storage devices; and a system disk unit, connected to the control unit, which stores system information for use by the control unit.

In this invention, it is preferable that the system disk unit store, at least, the log data of the control unit.

In this invention, it is preferable that upon occurrence of a power outage, the control unit write the data in the cache area of memory to the system disk unit.

In this invention, it is preferable that the control unit write the log data to the system disk unit.

In this invention, it is preferable that the system disk unit comprise at least one pair of system disk drives.

In this invention, it is preferable that the control unit have a CPU and a memory controller which connects the CPU, the memory, and the system disk unit.

In this invention, it is preferable that the system disk unit store firmware programs of the control unit.

In this invention, it is preferable that the system has a plurality of control modules that is connected to the plurality of disk storage devices.

In this invention, it is preferable that the system has a first switch unit to connect each of the control modules to the plurality of disk storage units.

In this invention, it is preferable that the control unit search the cache area of memory in response to read access by the higher-level host, and that when relevant data exists in the cache area, the relevant data be transferred from the cache memory to the higher-level host via the first interface portion, but that when relevant data does not exist in the cache area, the disk storage device storing the data be read-accessed via the second interface portion.

In this invention, a system disk is incorporated into a control module, so that even if problems occur in the path between the control module and the disk storage devices, if the control module and other paths are normal, the control module can read firmware and apparatus configuration backup data from the system disk, and operations using other paths are possible. Further, the control module can read and write log data to and from the system disk, enabling analysis upon occurrence of a fault and diagnostics for fault prevention.

Further, when at the time of occurrence of a power outage power is switched to batteries and the data in the cache memory area is backed up to a system disk, there is no need to supply power to a connected disk storage device, so that the battery capacity can be made small. Moreover, because there is no need to write backup data to a system disk via disk adapters and cables, the write time can be reduced, so that the battery capacity can be made small even when the cache memory capacity is large.

### BRIEF DESCRIPTION OF THE DRAWINGS

FIG. 1 shows the configuration of the data storage system of one embodiment of the invention;

FIG. 2 shows the configuration of the control modules of FIG. 1;

FIG. 3 shows the configuration of the back-end routers and disk enclosures of FIG. 1 and FIG. 2;

FIG. 4 shows the configuration of the disk enclosures of FIG. 1 and FIG. 3;

FIG. 5 explains read processing in the configuration of FIG. 1 and FIG. 2;

FIG. 6 explains write processing in the configuration of FIG. 1 and FIG. 2;

FIG. 7 shows the mounted configuration of the control module of one embodiment of the invention;

FIG. 8 shows a mounted configuration example of the data storage system of one embodiment of the invention;

FIG. 9 is a block diagram of the large-scale storage system of one embodiment of the invention; and, FIG. 10 shows the configuration of a storage system of the prior art.

### DESCRIPTION OF THE PREFERRED EMBODIMENTS

Below, embodiments of the invention are explained in the order of a data storage system, read/write processing, mounted configuration, and other embodiments.

Data Storage System

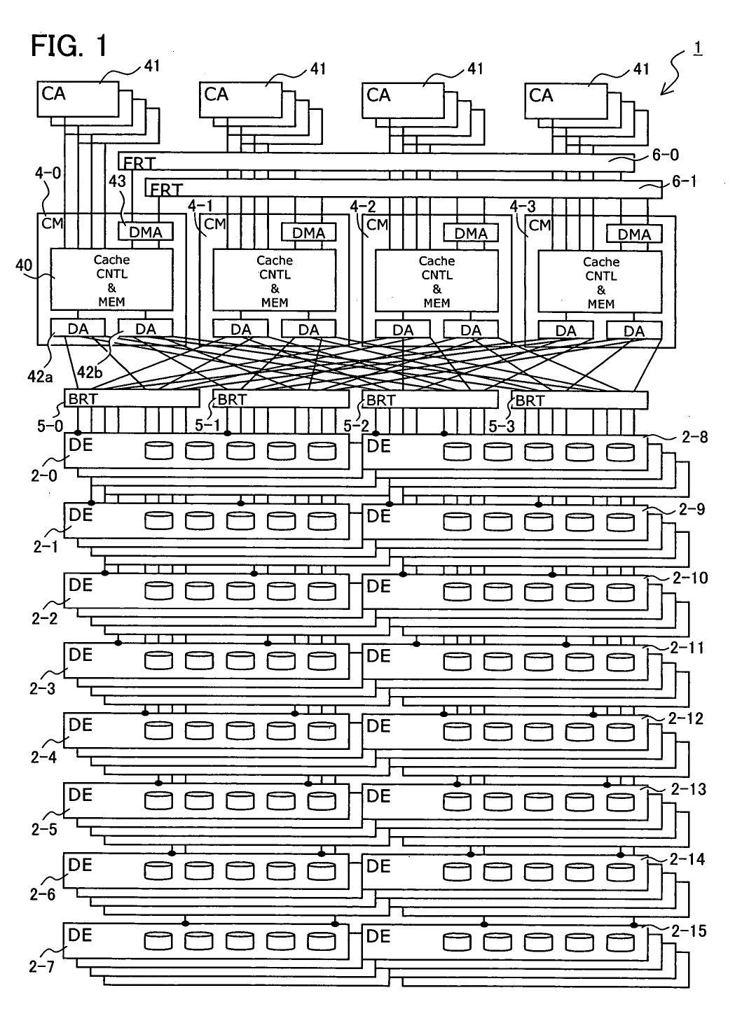

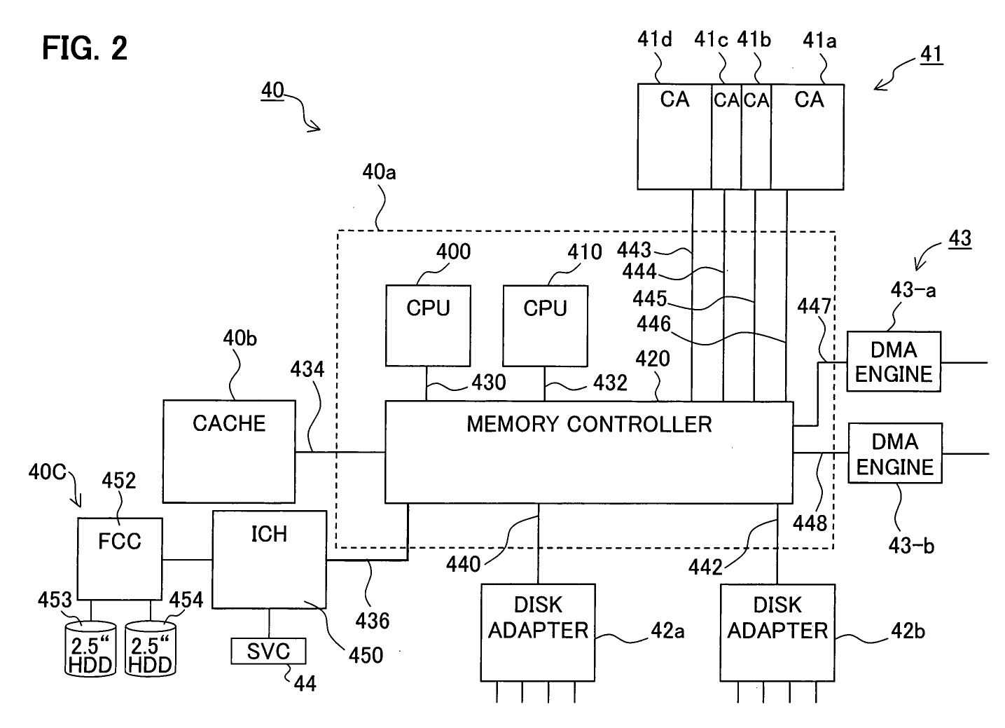

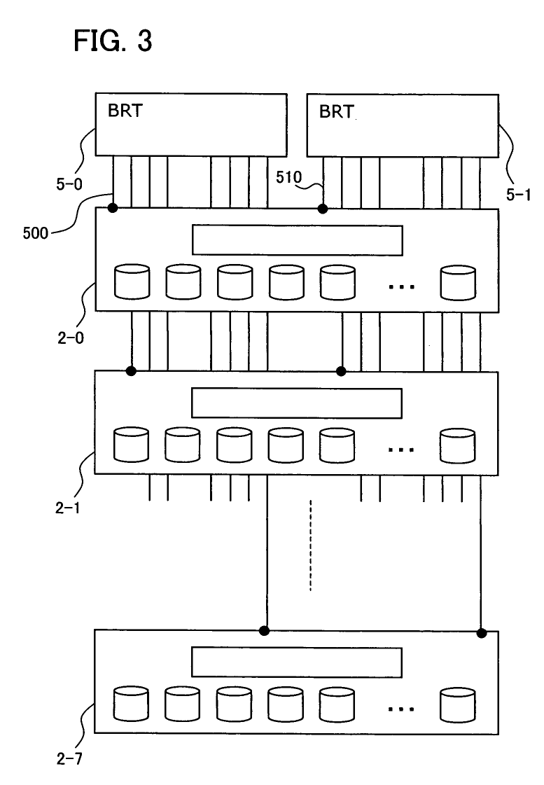

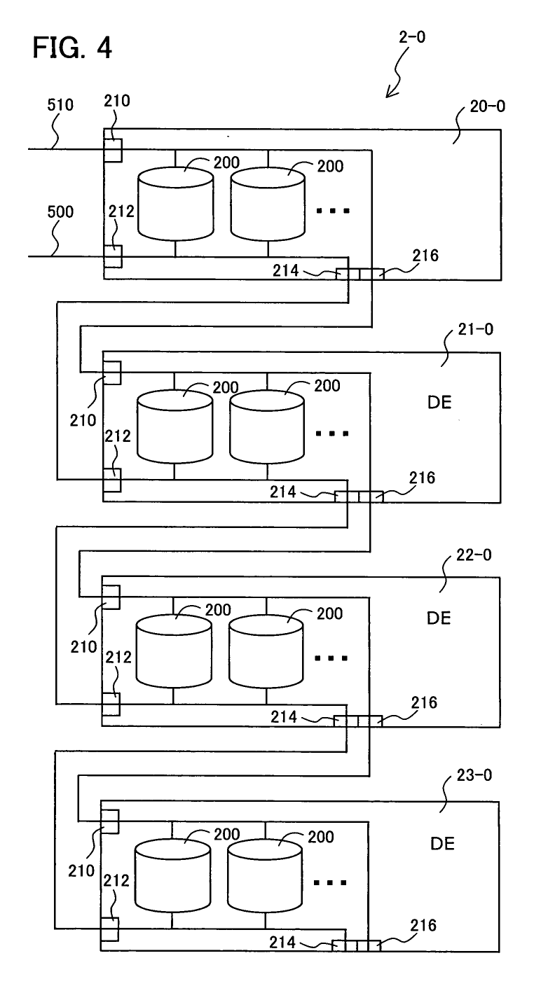

FIG. 1 shows the configuration of the data storage system of one embodiment of the invention, FIG. 2 shows the configuration of the control modules of FIG. 1, FIG. 3 shows the configuration of the back-end routers and disk enclosures of FIG. 1, and FIG. 4 shows the configuration of the disk enclosures of FIG. 1 and FIG. 3.

FIG. 1 shows, as an example of a data storage apparatus, a mid-scale disk array apparatus having four control modules. As shown in FIG. 1, the disk array apparatus 1 has a plurality of disk enclosures 2-0 to 2-15 which hold data; a plurality (here, four) of control modules 4-0 to 4-3, positioned between a host computer (data processing system), not shown, and the plurality of disk enclosures 2-0 to 2-15; a plurality (here, four) of back-end routers (first switch unit; hereafter “BRT”) 5-0 to 5-3, provided between the plurality of control modules 4-0 to 4-3 and the plurality of disk enclosures 2-0 to 2-15; and a plurality (here, two) of front-end routers (second switch units; hereafter “ERT”) 6-0, 6-1.

Each of the control modules 4-0 to 4-3 has a controller 40, channel adapters (first interface portions; hereafter “CA”) 41, disk adapters (second interface portions; hereafter “DA”) 42a, 42b, and DMA (Direct Memory Access) engines (communication portions; hereafter “DMA”) 43.

In FIG. 1, for simplicity in the drawing, the controller symbol “40”, disk adapter symbols “42a” and “42b”, and DMA symbol “43” are assigned only to the control module 4-0, and symbols are omitted for the constituent components of the other control modules 4-1 to 4-3.

The control modules 4-0 to 4-3 are explained using FIG. 2. The controllers 40 perform read/write processing based on processing requests (read requests or write requests) from a host computer, and has a memory 40b, a control unit 40a, and a system disk driver unit 40c.

The memory 40b has a cache area, which serves as a so-called cache for a plurality of disks, holding a portion of the data held in the plurality of disks of the disk enclosures 2-0 to 2-15; a configuration definition storage area; and other work areas.

The control unit 40a controls the memory 40b, the channel adapters 41, the device adapters 42, and the DMA 43, and so has one or a plurality (here, two) of CPUs 400, 410, and a memory controller 420. The memory controller 420 controls memory reading and writing, and also performs path switching.

The memory controller 420 is connected via a memory bus 434 to the memory 40b, via the CPU bus 430, 432 to the CPUs 400, 410, and via four-lane high-speed serial buses (for example, PCI-Express) 440, 442 to the disk adapters 42a, 42b.

Similarly, the memory controller 420 is connected via four-lane high-speed serial buses (for example, PCI-Express) 443, 444, 445, 446 to the channel adapters 41 (here, four channel adapters 41a, 41b, 41c, 41d), and via four-lane high-speed serial buses (for example, PCI-Express) 447, 448 to the DMA units 43 (here, two DMA units 43-a, 43-b).

The PCI (Peripheral Component Interconnect)-Express or other high-speed serial buses perform packet communication, and by providing a plurality of lanes in the serial buses, the number of signal lines can be reduced with minimal delays and fast response, in so-called low-latency communication.

Further, the memory controller 420 is connected via the serial bus 436 to the system disk drive unit 40c. The system disk drive unit 40c has a bridge circuit 450, a fiber channel circuit 452, and system disk drives 453, 454.

The bridge circuit 450 connects the memory controller 420 to the fiber channel circuit 452 and to a service processor 44 provided on the outside of the control module 4-0. The service processor 44 comprises, for example, a personal computer, and is used for system state confirmation, diagnostics and maintenance.

The fiber channel circuit 452 is connected to the system disk drives 453, 454 (here, two Hard Disk Drives). Hence the CPUs 400, 410 and similar can directly access the system disk drives 453, 454 via the memory controller 420. Further, the service processor 44 also can access the system disk drives 453, 454, via the bridge circuit 450. That is, the system disk drives 453, 454 are incorporated within the control module 4-0, and the CPUs 400, 410 can access the system disk drives 453, 454 without the intervention of the DAs 42a, 42b or the BRT 5-0.

The channel adapters 41a to 41d are interfaces with host computers; the channel adapters 41a to 41d are each connected to a different host computer. It is preferable that the channel adapters 41a to 41d are each connected to the interface portions of the corresponding host computers via a bus, such as for example a fiber channel or Ethernet (a registered trademark) bus; in this case, an optical fiber or coaxial cable is used as the bus.

Further, the channel adapters 41a to 41d are each configured as a portion of the control modules 4-0 to 4-3. These channel adapters 41a to 41d support a plurality of protocols as the interfaces with the corresponding host computers and the control modules 4-0 to 4-3.

Because protocols to be mounted are not the same, depending on the host computers supported, the controllers 40 which are the principal units of the control modules 4-0 to 4-3 are mounted on separated print boards, so that the channel adapters 41a to 41d can be replaced easily as necessary.

For example, protocols with host computers to be supported by the channel adapters 41a to 41d include, as described above, fiber channel and iSCSI (Internet Small Computer System Interface) supporting Ethernet (a registered trademark).

Further, as explained above, each of the channel adapters 41a to 41d is directly connected to the controller 40 by the bus 443 to 446, such as a PCI-Express bus, designed for connection of LSI (Large Scale Integrated) devices and print boards. By this means, the high throughput required between the channel adapters 41a to 41d and the controllers 40 can be achieved.

The disk adapters 42a, 42b are interfaces with each of the disk drives in the disk enclosures 2-0 to 2-15, and are connected to the BRTs 5-0 to 5-3 connected to the disk enclosures 2-0 to 2-15; here, the disk adapters 42a, 42b have four FC (Fiber Channel) ports.

As explained above, each of the disk adapters 42a, 42b is connected directly to the controller 40 by a bus, such as a PCI-Express bus, designed for connection to LSI (Large Scale Integrated) devices and print boards. By this means, the high throughput required between the disk adapters 42a, 42b and the controllers 40 can be achieved.

As shown in FIG. 1 and FIG. 3, the BRTs 5-0 to 5-3 are multi-port switches which selectively switch the disk adapters 42a, 42b of the control modules 4-0 to 4-3 and each of the disk enclosures 2-0 to 2-15 and make connections enabling communication.

As shown in FIG. 3, each of the disk enclosures 2-0 to 2-7 is connected to a plurality (here, two) of BRTs 5-0, 5-1. As shown in FIG. 4, a plurality (here, 15) of disk drives 200, each having two ports, are installed in each of the disk enclosures 2-0 to 2-7. The disk enclosure 2-0 is configured with the necessary number of unit disk enclosures 20-0 to 23-0, each having four connection ports 210, 212, 214, 216, connected in series, to obtain increased capacity. Here, up to a maximum four unit disk enclosures 20-0 to 23-0 can be connected.

Within each of the unit disk enclosures 20-0 to 23-0, each port of each disk drive 200 is connected to two ports 210, 212 by means of a pair of FC cables from the two ports 210, 212. As explained in FIG. 3, these two ports 210, 212 are connected to different BRTs 5-0, 5-1.

As shown in FIG. 1, each of the disk adapters 42a, 42b of the control modules 4-0 to 4-3 are connected to all the disk enclosures 2-0 to 2-15. That is, the disk adapters 42a of each of the control modules 4-0 to 4-3 are connected to the BRT 5-0 (see FIG. 3) connected to the disk enclosures 2-0 to 2-7, the BRT 5-0 connected to the disk enclosures 2-0 to 2-7, the BRT 5-2 connected to the disk enclosures 2-8 to 2-15, and the BRT 5-2 connected to the disk enclosures 2-8 to 2-15.

Similarly, the disk adapters 42b of each of the control modules 4-0 to 4-3 are connected to the BRT 5-1 (see FIG. 3) connected to the disk enclosures 2-0 to 2-7, the BRT 5-1 connected to the disk enclosures 2-0 to 2-7, the BRT 5-3 connected to the disk enclosures 2-8 to 2-15, and the BRT 5-3 connected to the disk enclosures 2-8 to 2-15.

In this way, each of the disk enclosures 2-0 to 2-15 is connected to a plurality (here, two) of BRTs, and different disk adapters 42a, 42b in the same control modules 4-0 to 4-3 are connected to the two BRTs connected to the same disk enclosures 2-0 to 2-15.

By means of such a configuration, each control module 4-0 to 4-3 can access all of the disk enclosures (disk drives) 2-0 to 2-15 via either of the disk adapters 42a, 42b, and via any path.

As shown in FIG. 2, each disk adapter 42a, 42b is connected to the corresponding BRT 5-0 to 5-3 by a bus, such as for example a fiber channel or Ethernet (a registered trademark) bus. In this case, as explained below, the bus is provided as electrical wiring on the print board of the back panel.

As explained above, one-to-one mesh connections are provided between the disk adapters 42a, 42b of each of the control modules 4-0 to 4-3 and the BRTs 5-0 to 5-3 to connect all the disk enclosures, so that as the number of control modules 4-0 to 4-3 (that is, the number of disk adapters 42a, 42b) increases, the number of connections increases and connections become complex, so that physical mounting becomes difficult. However, by adopting fiber channels, requiring few signals to construct an interface, as the connections between the disk adapters 42a, 42b and the BRTs 5-0 to 5-3, mounting on the print board becomes possible.

When each of the disk adapters 42a, 42b and corresponding BRTs 5-0 to 5-3 are connected by a fiber channel, the BRTs 5-0 to 5-3 are fiber channel switches. Further, the BRTs 5-0 to 5-3 and the corresponding disk enclosures 2-0 to 2-15 are for example connected by fiber channels; in this case, because the modules are different, connection is by optical cables 500, 510.

As shown in FIG. 1, the DMA engines 43 communicate with each of the control modules 4-0 to 4-3, and handle communication and data transfer processing with the other control modules. Each of the DMA engines 43 of the control modules 4-0 to 4-3 is configured as a portion of the control modules 4-0 to 4-3, and is mounted on the board of the controller 40 which is a principal unit of the control modules 4-0 to 4-3. Each DMA engine is directly coupled to the controllers 40 by means of the high-speed serial bus described above, and also communicate with the DMA engines 43 of the other control modules 4-0 to 4-3 via the FRTs 6-0, 6-1.

The FRTs 6-0, 6-1 are connected to the DMA, engines 43 of a plurality (in particular three or more; here, four) of control modules 4-0 to 4-3, selectively switches among these control modules 4-0 to 4-3, and makes connections enabling communication.

By means of this configuration, each of the DMA engines 43 of the control modules 4-0 to 4-3 executes communication according to access request and similar from a host computer and data transfer processing (for example, mirroring processing) via the FRT6-0, 6-1 between the controller 40 to which it is connected and the controllers 40 of other control modules 4-0 to 4-3.

Further, as shown in FIG. 2, the DMA engine 43 of each control module 4-0 to 4-3 comprise a plurality (here, two) of DMA engines 43-a, 43-b; each of these two DMA engines 43-a, 43-b uses two FRTs 6-0, 6-1.

As indicated in FIG. 2, the DMA engines 43-a, 43-b are connected to the controller 40 by, for example, a PCI-Express bus. That is, in communication and data transfer (DMA) processing between the control modules 4-0 to 4-3 (that is, between the controllers 40 of the control modules 4-0 to 4-3), large amounts of data are transferred, and it is desirable that the time required for transfer be short, so that a high throughput as well as low latency (fast response time) are demanded. Hence as shown in FIG. 1 and FIG. 2, the DMA engines 43 and the FRTs 6-0, 6-1 of the control modules 4-0 to 4-3 are connected by a bus which utilizes high-speed serial transfer (PCI-Express or Rapid-IO) which is designed so as to satisfy the demands for both high throughput and low latency.

The PCI-Express and Rapid-IO buses employ high-speed serial transfer at 2.5 Gbps; a small-amplitude differential interface called LVDS (Low Voltage Differential Signaling) is adopted as the bus interface.

Read/Write Processing

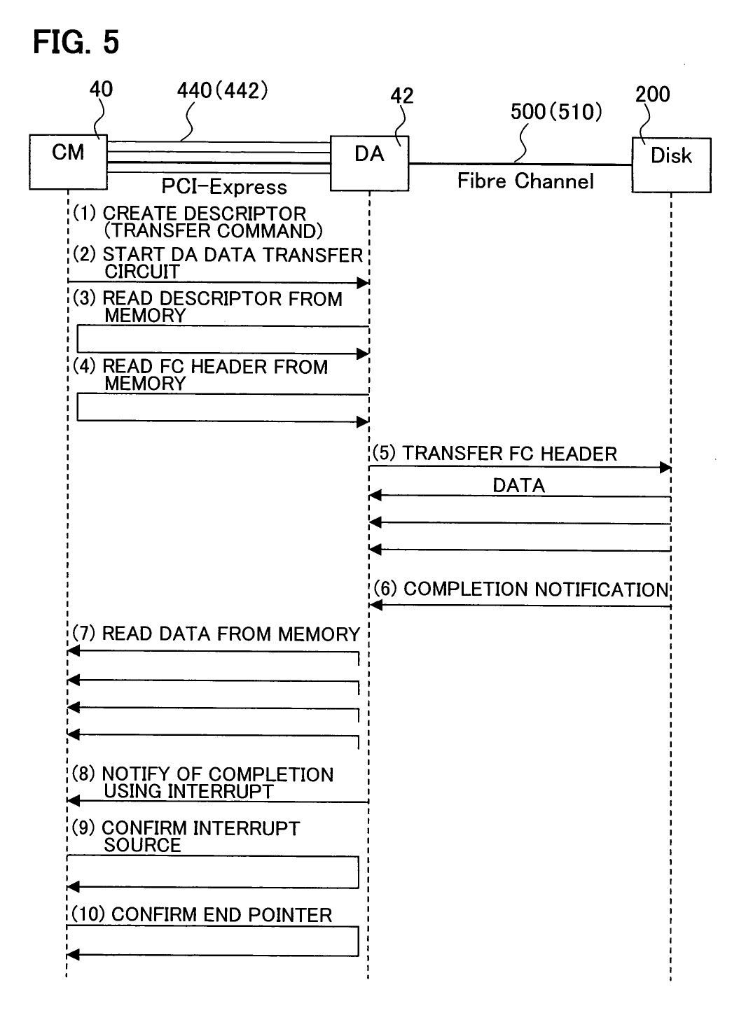

Next, read processing in the data storage system of FIG. 1 through FIG. 4 is explained. FIG. 5 explains read operation in the configuration of FIG. 1 and FIG. 2.

First, when a control unit (cache manager) 40 receives a read request via the channel adapter 41a to 41d from one of the corresponding host computers, if the target data of the read request is held in the cache memory 40b, the target data held in the cache memory 40b is sent to the host computer via the channel adapter 41a to 41d.

If on the other hand the target data is not held in the cache memory 40b, the cache manager (control portion) 40a first reads the target data from the disk drive 200 holding the relevant data into the cache memory 40b, and then transmits the target data to the host computer issuing the read request.

Processing to read the disk drive is explained in FIG. 5.

(1) The control unit 40a (CPU) of the cache manager 40 creates a FC header and descriptor in the descriptor area of the cache memory 40. A descriptor is a command requesting data transfer by a data transfer circuit, and contains the address in the cache memory of the FC header, the address in the cache memory of the data to be transferred, the number of data bytes, and the logical address of the disk for data transfer.

(2) The data transfer circuit of the disk adapter 42 is started.

(3) The started data transfer circuit of the disk adapter 42 reads the descriptor from the cache memory 40b.

(4) The started data transfer circuit of the disk adapter 42 reads the FC header from the cache memory 40b.

(5) The started data transfer circuit of the disk adapter 42 decodes the descriptor and obtains the request disk, leading address, and number of bytes, and transfers the FC header to the target disk drive 200 using the fiber channel 500 (510). The disk drive 200 reads the requested data, and transmits the data over the fiber channel 500 (510) to the data transfer circuit of the disk adapter 42.

(6) Upon having read and transmitted the requested data, the disk drive 200 transmits a completion notification over the fiber channel 500 (510) to the data transfer circuit of the disk adapter 42.

(7) Upon receiving the completion notification, the data transfer circuit of the disk adapter 42 reads the read data from the memory of the disk adapter 42 and stores the data in the cache memory 40b.

(8) When read transfer is completed, the started data transfer circuit of the disk adapter 42 uses an interrupt to send completion notification to the cache manager 40.

(9) The control unit 42a of the cache manager 40 obtains the interrupt source of the disk adapter 42 and confirms the read transfer.

(10) The control unit 42a of the cache manager 40 checks the end pointer of the disk adapter 42 and confirms the completion of read transfer.

Thus in order to obtain sufficient performance, high throughput must be maintained over all connections, but many signals (here, seven) are exchanged between the cache control portion 40 and the disk adapter 42, and a low-latency bus is especially important.

In this embodiment, both the PCI-Express (four-lane) bus and the Fiber Channel (4G) bus are adopted as connections having high throughput; but whereas PCI-Express is a low-latency connection, Fiber Channel is a comparatively high latency (time is required for data transfer) connection.

In this embodiment, fiber channel can be adopted in the BRTs 5-0 to 5-3 for the configuration of FIG. 1. In order to achieve low latency, although the number of bus signals cannot be decreased beyond a certain number, in this embodiment fiber channel with a small number of signal lines can be used for the connection between the disk adapters 42 and the BRTs 5-0; the number of signals on the back panel is reduced, providing advantages for mounting.

Next, write operation is explained. When a write request is received from one of the host computers via the corresponding channel adapter 41a to 41d, the channel adapter 41a to 41d which has received the write request command and write data queries the cache manager 40 for the address in the cache memory 40b to which to write the write data.

When the channel adapter 41a to 41d receives the response from the cache manager 40, the channel adapter 41a to 41d writes the write data to the cache memory 40b of the cache manager 40, and in addition writes the write data to the cache memory 40b in at least one cache manager 40 different from the cache manager 40 in question (that is, the cache manager 40 of a different control module 4-0 to 4-3). For this purpose the DMA engine 43 is started, and the write data is also written to the cache memory 40b in the cache manager 40 of another control module 4-0 to 4-3, via an FRT 6-0, 6-1.

Here, the write data is written to the cache memory 40b of at least two different control modules 4-0 to 4-3 in order to achieve data redundancy (mirroring), so that even in the event of an unforeseen hardware failure of a control module 4-0 to 4-3 or cache manager 40, data loss can be prevented.

Finally, when writing of cache data to the plurality of cache memory units 40b ends normally, the channel adapter 41a to 41d sends notification of completion to the host computer, and processing ends.

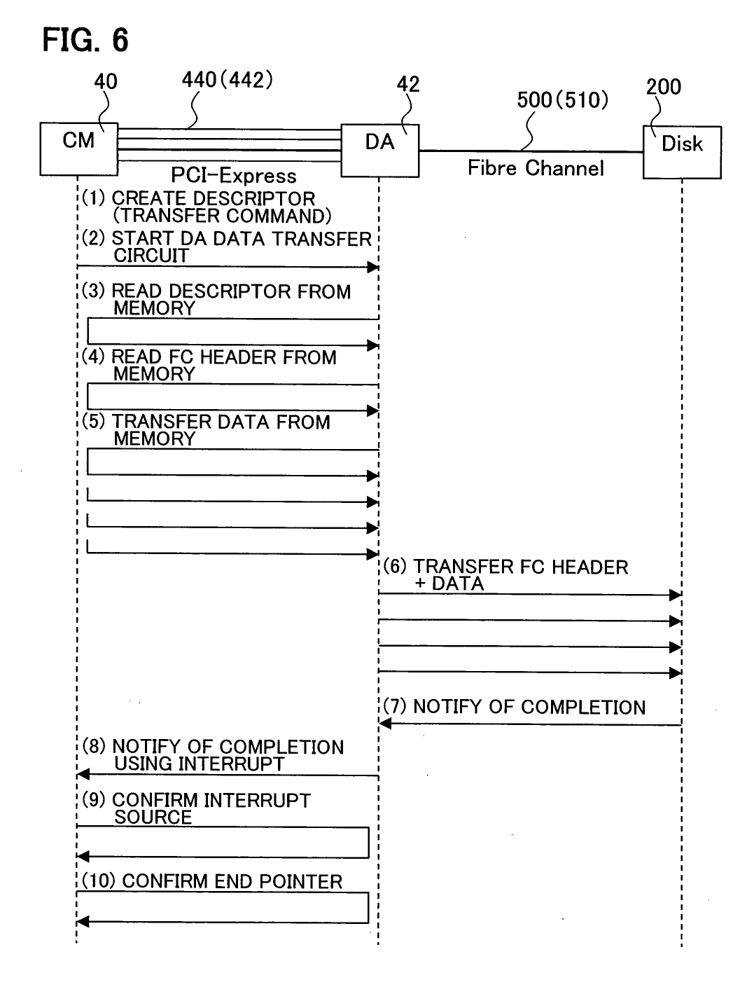

The write data must then be written back (write-back) to the relevant disk drive. The cache control unit 40a writes back the write data in the cache memory 40b to the disk drive 200 holding the target data, according to an internal schedule. This write processing to the disk drive is explained using FIG. 6.

(1) The control unit 40a (CPU) of the cache manager 40 creates an FC header and descriptor in the descriptor area of the cache memory 40b. The descriptor is a command requesting data transfer by a data transfer circuit, and contains the address in cache memory of the FC header, the address in cache memory of the data to be transferred, the number of data bytes, and the logical address of the disk for data transfer.

(2) The data transfer circuit of the disk adapter 42 is started.

(3) The started data transfer circuit of the disk adapter 42 reads the descriptor from the cache memory 40b.

(4) The started data transfer circuit of the disk adapter 42 reads the FC header from the cache memory 40b.

(5) The started data transfer circuit of the disk adapter 42 decodes the descriptor and obtains the request disk, leading address, and number of bytes, and reads the data from the cache memory 40b.

(6) After the completion of reading, the data transfer circuit of the disk adapter 42 transfers the FC header and data to the relevant disk drive 200 via fiber channel 500 (510). The disk drive 200 writes the transferred data to an internal disk.

(7) Upon completion of data writing, the disk drive 200 sends notification of completion to the data transfer circuit of the disk adapter 42 via the fiber channel 500 (510).

(8) Upon receiving notification of completion, the started data transfer circuit of the disk adapter 42 uses an interrupt to send completion notification to the cache manager 40.

(9) The control unit 40a of the cache manager 40 obtains the interrupt source of the disk adapter 42 and confirms the write operation.

(10) The control unit 40a of the cache manager 40 checks the end pointer of the disk adapter 42 and confirms the completion of the write operation.

In both FIG. 5 and FIG. 6, arrows indicate the transfer of data and other packets, and U-shaped arrows represent data reading, indicating that data is sent back in response to a data request. Because starting of the control circuit in the DA and confirmation of the end state are necessary, seven exchanges of signals are necessary between the CM 40 and DA 42 in order to perform a single data transfer. Between the DA 42 and the disk 200, two signal exchanges are required.

Thus it is clear that low latency is required for the connection between the cache control unit 40 and the disk adapter 42, whereas an interface with fewer signals can be used between the disk adapter 42 and the disk device 200.

Next, read/write access of the above-described system disk drives 453, 454 is explained. Read/write access from the CM (CPU) is similar to that in FIG. 5 and FIG. 6, with DMA transfer performed between the memory 40b and the system disk drives 453, 454. That is, a DMA circuit is provided in the fiber channel circuit 452 of FIG. 2, and the CPU 400 (410) prepares a descriptor and starts the DMA circuit of the fiber channel circuit 452.

For example, reading of firmware, log data, and backup data (including data saved from the cache area) on the system disk drive 453 (454) is similar to that of FIG. 5; the CPU 400 (410) creates an FC header and descriptor, and by starting the DMA, circuit (read operation) of the fiber channel circuit 452, the firmware, log data, and backup data is transferred by the DMA from the system disk drive 453, 454 to the memory 40b.

Similarly, writing of the log data and the backup data is similar to that in FIG. 6; the CPU 400 (410) creates an FC header and descriptor, and by starting the DMA circuit (write operation) of the fiber channel circuit 452, log data and backup data is transferred by the DMA to the system disk drive 453, 454 from the memory 40b.

By thus incorporating the system disks into the controllers, even when problems arise in a path between the controllers, the BRTs and the disk enclosures, if the controller and other paths are normal, firmware and apparatus configuration backup data can be read by the controller from the system disk, and operations employing other paths are possible. Moreover, a controller can read and write log data to and from a system disk, so that analysis upon occurrence of a fault and diagnostics for fault prevention are possible.

Further, when in the event of a power outage the power is switched to batteries and the data in the cache memory is backed up to a system disk, there is no need to supply power to a disk enclosure, so that the battery capacity can be made small. And, because there is no need to write backup data to a system disk via a disk adapter or cable, the write time can be shortened, so that the battery capacity can be made small even for a large write memory capacity.

Further, because a pair of system disk drives is provided in a redundant configuration, even if a fault were to occur in one of the system disk drives, backup using the other system disk drive would be possible. That is, a RAID-1 configuration can be adopted.

The service processor 44 of FIG. 2 can also access the system disk drives 453, 454 via the bridge circuit 450. Firmware and apparatus configuration data are downloaded from the service processor 44 to the system disk drives 453, 454. Further, even in the event of an anomaly in a control portion 40a, log data can be retrieved from the system disk by the service processor 44, so that fault diagnostics and similar can be executed.

Mounted Configuration

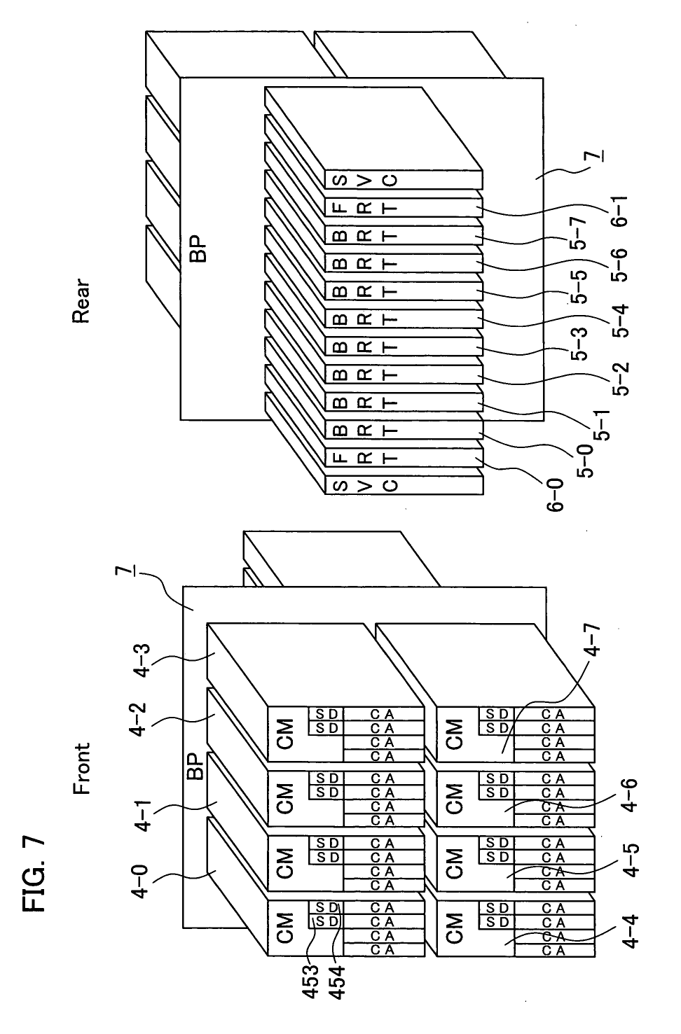

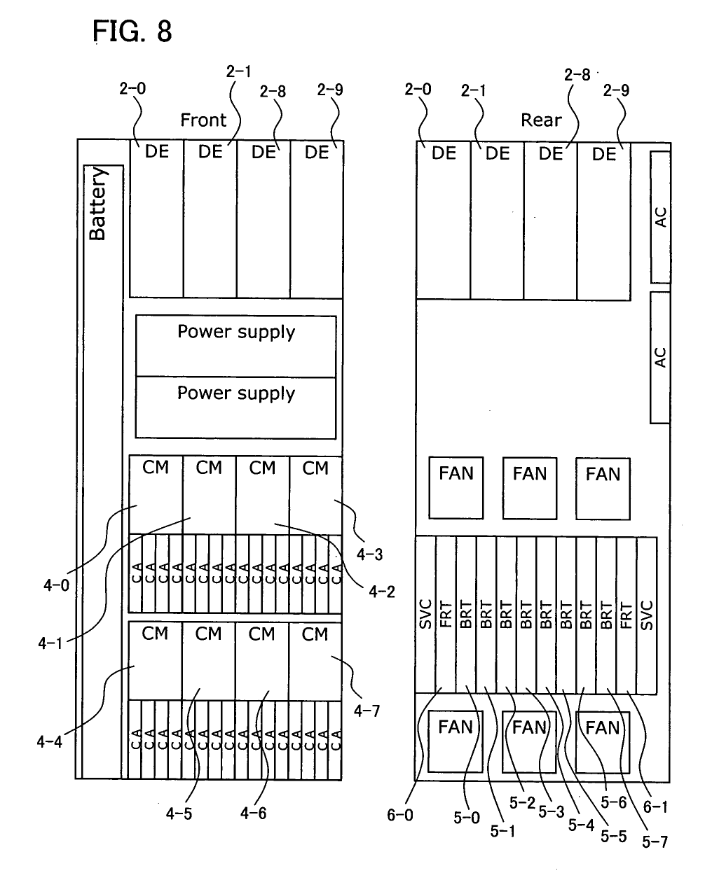

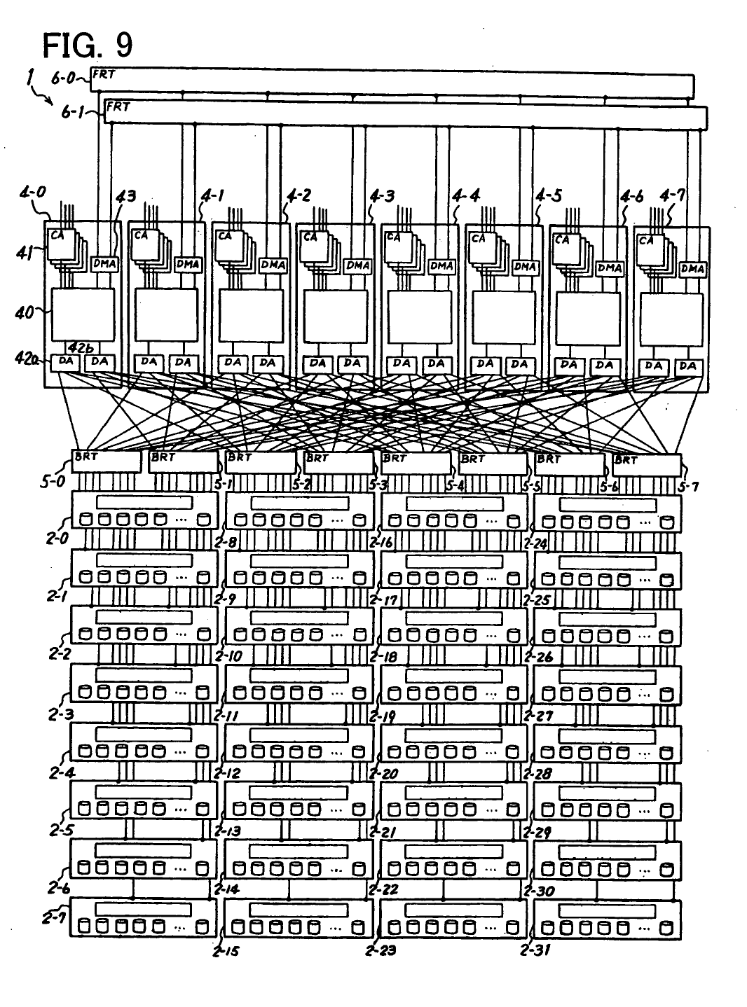

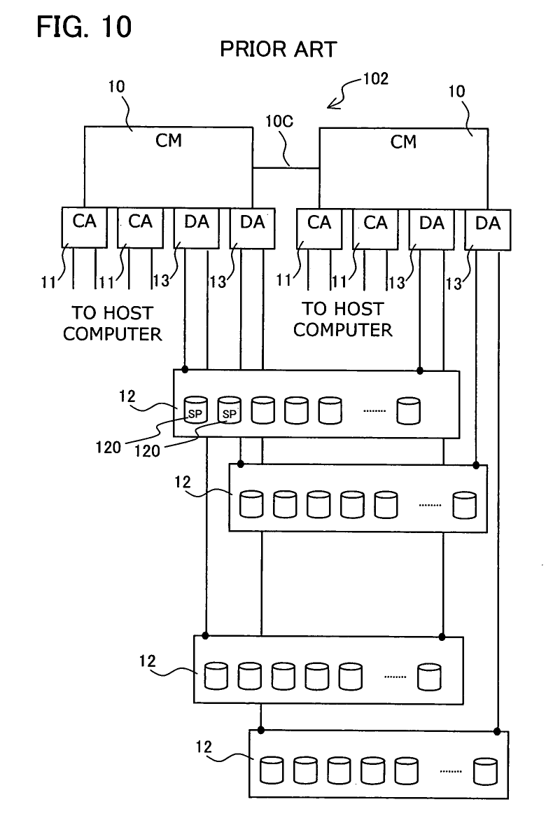

FIG. 7 shows an example of the mounted configuration of a control module of this invention, FIG. 8 shows a mounted configuration example, including the control modules and the disk enclosures in FIG. 7, of one embodiment of the invention, and FIG. 9 is a block diagram of a data storage system with this mounted configuration.

As shown in FIG. 8, on the upper side of the storage apparatus housing are installed four disk enclosures 2-0, 2-1, 2-8, 2-9. Control circuits are installed in the lower half of the storage apparatus. As shown in FIG. 7, the lower half is divided into front and back by a back panel 7. Slots are provided in the front side and in the back side of the back panel 7. This is an example of the mounted structure of a storage system with the large-scale configuration of FIG. 9; but the configuration of FIG. 1 is similar, although the number of CMs is different.

That is, the configuration in FIG. 9 has eight control modules (CMs) 4-0 to 4-7, eight BRTs 5-0 to 5-7, and 32 disk enclosures 2-0 to 2-31. Otherwise the configuration is the same as in FIG. 1.

As shown in FIG. 7, in the configuration of FIG. 9, eight CMs 4-0 to 4-7 are positioned on the front side, and two FRTs 6-0 and 6-1, eight BRTs 5-0 to 5-7, and a service processor SVC (symbol “44” in FIG. 2) providing power supply control and similar, are positioned on the rear side.

Two system disk drives 453, 454 are provided in each of the CMs 4-0 to 4-7. In FIG. 7, the symbols “453” and “454” are assigned to the system disk drives (SDs) of CM 4-0; the configuration is similar for the other CMs 4-1 to 4-7, but in FIG. 7 these are omitted in order to avoid complicating the drawing.

In FIG. 7, the eight CMs 4-0 to 4-7 and two FRTs 6-0, 6-1 are connected, via the back panel 7, to a four-lane PCI-Express bus. The PCI-Express has four signal lines (for differential, bidirectional communication) in a lane, so that there are 16 signal lines in four lanes, and the total number of signal lines is 16×16=256. The eight CMs 4-0 to 4-7 and eight BRTs 5-0 to 5-7 are connected via the back panel 7 to fiber channel. For differential, bidirectional communication, the fiber channel has 1×2×2=4 signal lines, and there are 8×8×4=256 such signal lines.

Thus by selectively utilizing buses at different connection points, even in a large-scale storage system such as that of FIG. 9, connections between eight CMs 4-0 to 4-7, two FRTs 6-0 and 6-1, and eight BRTs 5-0 to 5-7 can be achieved using 512 signal lines. This number of signal lines can be mounted without problem on a back panel board 7, and six signal layers on the board are sufficient, so that in terms of cost this configuration is fully realizable.

In FIG. 8, four disk enclosures, 2-0, 2-1, 2-8, 2-9 (see FIG. 9) are installed; the other disk enclosures, 2-3 to 2-7 and 2-10 to 2-31, are provided in separate housings.

Because one-to-one mesh connections are provided between the disk adapters 42a, 42b of each of the control modules 4-0 to 4-7 and the BRTs 5-0 to 5-7, even if the number of control modules 4-0 to 4-7 comprised by the system (that is, the number of disk adapters 42a, 42b) is increased, fiber channel with a small number of signal lines comprised by the interface can be employed for connection of the disk adapters 42a, 42b to the BRTs 5-0 to 5-7, so that problems arising from mounting can be resolved.

Thus if, for example, system disk drives of size approximately 2.5 inches are used, mounting (incorporation) in CM 4-0 and similar is easily accomplished, and so no problems are posed by mounting.

Other Embodiments

In the above embodiments, signal lines within control modules were taken to be PCI-Express lines; but Rapid-IO or another high-speed serial bus can be used. The numbers of channel adapters and the disk adapters within the control modules can be increased or decreased as necessary.

As the disk drives, hard disk drives, optical disc drives, magneto-optical disc drives, and other storage devices can be employed. Further, the configuration of the storage system and controllers (control modules) is not limited to those of FIG. 1 and FIG. 9, and application to other configurations (such as for example that of FIG. 10) is possible.

In the above, embodiments of this invention have been explained, but various modifications can be made within the scope of the invention, and these modifications are not excluded from the scope of the invention.

Because system disks are incorporated into control modules, even if problems occur in a path between a control module and a disk storage device, if the control module and another path are normal the control module can read system information from a system disk and can operate using the other path. Further, a control module can read and write log data to and from a system disk, so that analysis upon occurrence of a fault and diagnostics for fault prevention are possible.

Further, when in the event of a power outage the power is switched to batteries and the data in cache memory is backed up to a system disk, there is no need to supply power to connected disk storage devices, so that the battery capacity can be made small. And, because there is no need to write backup data to a system disk via a disk adapter or cable, the write time can be shortened, so that the battery capacity can be made small even for a large write memory capacity, contributing to cost reductions in the storage system.

What is claimed is:

1. A data storage system comprising:
a plurality of disk storage devices which store data; and
a control module, connected to said plurality of disk storage devices, which controls access to said disk storage devices according to access instructions from a higher-level host,
wherein said control module comprises:
memory having a cache area which stores a portion of the data stored in said disk storage devices;
a control unit, which performs said access control;
a first interface unit, which controls the interface with said higher-level host;
a second interface unit, which controls the interface with said plurality of disk storage devices; and
a system disk unit, connected to said control unit, which stores system information for use by said control unit.

2. The data storage system according to claim 1,
wherein said system disk unit stores, at least, log data of said control unit.

3. The data storage system according to claim 1,
wherein, upon occurrence of a power outage, said control unit writes the data in said cache area of said memory to said system disk unit.

4. The data storage system according to claim 2,
wherein said control unit writes said log data to said system disk unit.

5. The data storage system according to claim 1,
wherein said system disk unit comprises at least one pair of system disk drives.

6. The data storage system according to claim 1,
wherein said control unit has a CPU and a memory controller which connects said CPU, said memory, and said system disk unit.

7. The data storage system according to claim 1,
wherein said system disk unit stores firmware programs of said control unit.

8. The data storage system according to claim 1,
wherein said system has a plurality of said control modules connected to said plurality of disk storage devices.

9. The data storage system according to claim 1,
wherein each of said control modules has a first switch unit for connection to said plurality of disk storage units.

10. The data storage system according to claim 1,
wherein, in response to read access from said higher-level host, said control unit searches said cache area of said memory, and when target data exists in said cache area, transfers said target data from said cache memory to said host-level host via said first interface unit, but when the target data does not exist in said cache area, accesses and reads, via said second interface unit, said disk storage device storing said data.

11. A data storage control apparatus, connected to a plurality of disk storage devices which store data, and which, according to access instructions from a higher-level host, controls access to said disk storage devices, comprising:
a memory having a cache area which stores a portion of the data stored in said disk storage devices;
a control unit, which performs said access control;
a first interface unit, which controls the interface with said higher-level host;
a second interface unit, which controls the interface with said plurality of disk storage devices; and
a system disk unit, connected to said control unit, which stores system information for use by said control unit.

12. The data storage control apparatus according to claim 11, wherein said system disk unit stores, at least, log data of said control unit.

13. The data storage control apparatus according to claim 11, wherein, upon occurrence of a power outage, said control unit writes the data in said cache area of said memory to said system disk unit.

14. The data storage control apparatus according to claim 12, wherein said control unit writes said log data to said system disk unit.

15. The data storage control apparatus according to claim 11, wherein said system disk unit comprises at least one pair of system disk drives.

16. The data storage control apparatus according to claim 11, wherein said control unit has a CPU and a memory controller which connects said CPU, said memory, and said system disk unit.

17. The data storage control apparatus according to claim 11, wherein said system disk unit stores firmware programs of said control unit.

18. The data storage control apparatus according to claim 11, wherein said system having a plurality of control modules having said memory, said control unit, said first interface unit, said second interface unit, and said system disk unit,
and wherein said plurality of control modules are connected to said plurality of disk storage devices.

19. The data storage control apparatus according to claim 11, wherein further comprising a first switch unit for connecting each of said second interface unit of said control module to said plurality of disk storage units.

20. The data storage control apparatus according to claim 11, wherein, in response to read access from said higher-level host, said control unit searches said cache area of said memory, and when target data exists in said cache area, transfers said target data from said cache memory to said higher-level host via said first interface unit, but when said target data does not exist in said cache area, accesses and reads, via said second interface unit, said disk storage device storing said data.
